(19) United States
(12) Patent Application Publication
(10) Pub. No.: US 2022/0324694 A1
(43) Pub. Date: Oct. 13, 2022

(54) FILLING DEVICE AND APPARATUS FOR HYDRATION BLADDERS AND OTHER FLUID RECEPTACLES, AND HYDRATION BLADDER HAVING THE SAME

(71) Applicants: John M. Voss, Garden Plain, KS (US); Brian J. Waltman, JR., Lakewood, CO (US)

(72) Inventors: John M. Voss, Garden Plain, KS (US); Brian J. Waltman, JR., Lakewood, CO (US)

(21) Appl. No.: 17/226,074

(22) Filed: Apr. 8, 2021

(51) Int. Cl. B67D 7/02; A45F 3/20

(52) U.S. Cl. CPC B67D 7/0288; A45F 3/20

(57) ABSTRACT

Filling devices disclosed herein comprise a container having an open end, a first tubular attachment in fluid communication with the interior of the container, a second tubular attachment in fluid communication with the interior of the container, and a removable and re-installable closure or cap for the open end of the container. Hydration systems disclosed herein comprise a hydration bladder, a first hose section, a filling device in accordance with the embodiments herein, a second hose section, and a mouthpiece. The first hose section connects the hydration bladder to the filling device, and the second hose section connects the filling device to the mouthpiece.

### BACKGROUND

### Technical Field

The present invention generally relates to devices, apparatuses, and systems for filtering, filling and/or adding water or fluid into hydration bladders and water or fluid bladders, receptacles, container, and the like, and hydration bladders having filling devices, apparatuses, and systems. More specifically, the embodiments of the present invention disclosed herein relate to filling devices and apparatuses for filling hydration bladders and water or fluid bladders, receptacles, container, and the like, and also relate to hydration bladders or systems employing such filing devices or apparatuses.

### Description of the Related Art

Filling devices, apparatuses, and systems for filling hydration bladders and other water or fluid containers, receptacles, and the like, and hydration bladders or systems having filling devices, apparatuses, and systems, have been previously proposed in the art. However, the previously known filling devices, apparatuses, and systems for filling hydration bladders and other water or fluid containers, receptacles, and the like, lack the advantageous features of the embodiments of the present invention disclosed herein below.

One advantage of the present invention over the prior art is that it allows for a user to add water and/or fluids into a hydration bladder or a water or fluid bladder, receptacle, container, and the like easily and quickly.

Another advantage of the present invention over the prior art is that it allows for a hydration bladder or system to be filled with water and/or fluids easily and quickly.

### SUMMARY OF THE PRESENT INVENTION

The embodiments of the present invention disclosed herein relate to devices and apparatuses for filling hydration bladders and other water or fluid containers, receptacles, and the like, and also relate to hydration bladders or systems employing such devices or apparatuses. Some embodiments of the filling devices disclosed herein comprise a container having an open end, a first tubular attachment in fluid communication with the interior of the container, a second tubular attachment in fluid communication with the interior of the container, and a removable and re-installable closure for the open end of the container. Some embodiments of the hydration systems disclosed herein comprise a hydration bladder, a first hose section, a filling device in accordance with the embodiments herein, a second hose section, and a mouthpiece. The first hose section connects the hydration bladder to the filling device, and the second hose section connects the filling device to the mouthpiece.

The hydration systems herein are typically used with a backpack. An industry standard water filtration system, such as, but not limited to, the SAWYER® SQUEEZE and the KATADYN® BEFREE can be attached or secured to the filling device to fill the hydration bladder with filtered water. When filling is completed, the water filtration system is removed from the filling device and the closure or cap of the filling device is used to close off the open end of the container of the filling device to seal the hydration system from the atmosphere. The filling devices herein are capable of being retrofitted to industry standard hydration bladder systems. The water line between the bladder and the mouthpiece can be cut to allow the installation of a filling device in accordance with the embodiments herein.

The filling devices herein allow a hydration bladder, or other water or fluid containers, receptacles, and the like, to be filled, or water to be added to the hydration bladder, without the need for removing the hydration bladder from a backpack in which the hydration bladder is typically carried, dismounting the backpack from the back of a person using or carrying the hydration bladder and backpack in some cases, or even opening the backpack to expose the hydration bladder in some cases. Some additional advantages of the embodiments herein include:

1) they make filling the bladder easy by allowing the bladder to be filled while inside the backpack;

2) water spillage on the backpack is prevented or reduced in frequency; and

3) puts filtered (safe) water directly into the bladder, and the bladder never comes into contact with contaminated or unsafe water.

Some embodiments herein are directed to a hydration device or system comprising a filling device in accordance with the embodiments disclosed.

These and other advantages of the embodiments herein will become further evident upon study of the drawings or figures of this application and the detailed description below.

### BRIEF DESCRIPTION OF THE DRAWINGS

FIG. 1 is a perspective view of an illustrative embodiment of a filling device according to the present invention, shown in a closed position;

FIG. 2 is an exploded, perspective view of the filling device of FIG. 1, similar to the filing device shown in an open position;

FIG. 3 is a top, perspective view of a cap of the filling device of FIG. 1;

FIG. 4 is a bottom, perspective view of the cap of FIG. 3;

FIG. 5 is a top, perspective view of a container of the filling device of FIG. 1;

FIG. 6 is a bottom, perspective view of the container of FIG. 5;

FIG. 7 is a cross-sectional view of the filling device of FIG. 1;

FIG. 8 is a right side, or left side (which is a mirror image of the right side), view of the filling device of FIG. 1;

FIG. 9 is an environmental view of the filling device of FIG. 1, with a cap detached or unsecured from a container, with a water of fluid source attached or secured to the container, and with the filling device (without the cap) attached or secured to a hydration bladder system;

FIG. 10 is an environmental view of the filling device of FIG. 1, with a cap attached or secured to a container, and with the filling device attached or secured to a hydration bladder system;

FIG. 11 is a front view of another illustrative embodiment of a filling device according to the present invention, shown in a closed position;

FIG. 12 is a rear view of the filling device of FIG. 10;

FIG. 13 is a left side view of the filling device of FIG. 10;

FIG. 14 is a right side view of the filling device of FIG. 10;

FIG. 15 is a top view of the filling device of FIG. 10;

FIG. 16 is a bottom view of the filling device of FIG. 10;

FIG. 17 is an environmental view of the filling device of FIG. 10, with a cap detached or unsecured from a container, with a water of fluid source attached or secured to the container, and with the filling device (without the cap) attached or secured to a hydration bladder system;

FIG. 18 is an environmental view of the filling device of FIG. 10, with a cap attached or secured to a container, and with the filling device attached or secured to a hydration bladder system;

FIGS. 19-38 . . . ; and

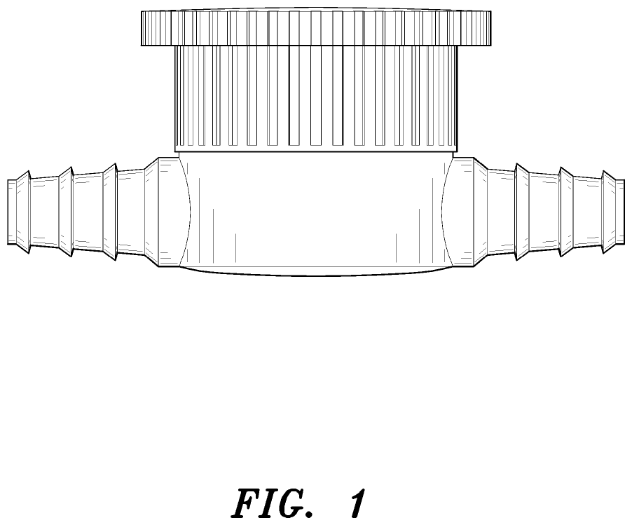

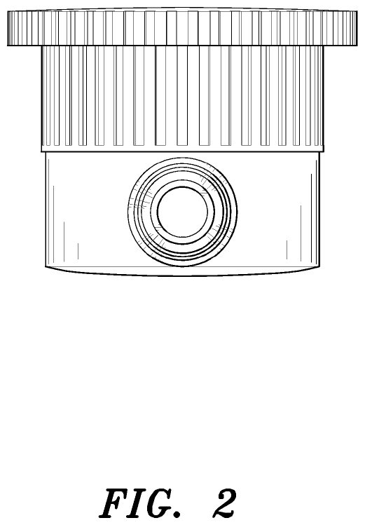

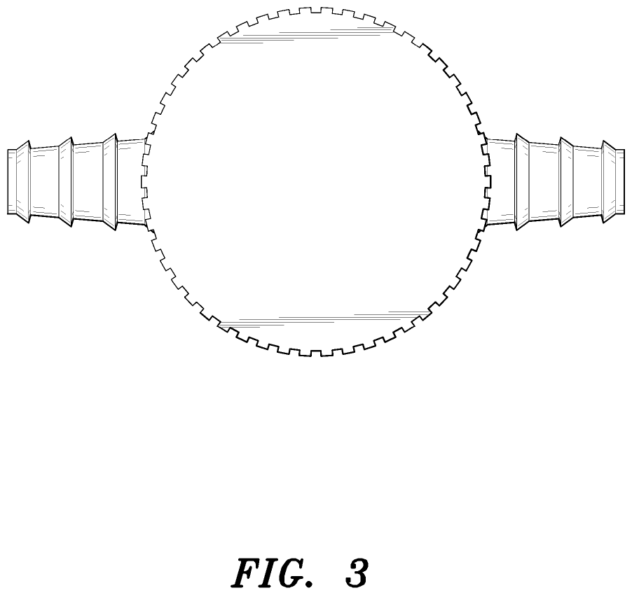

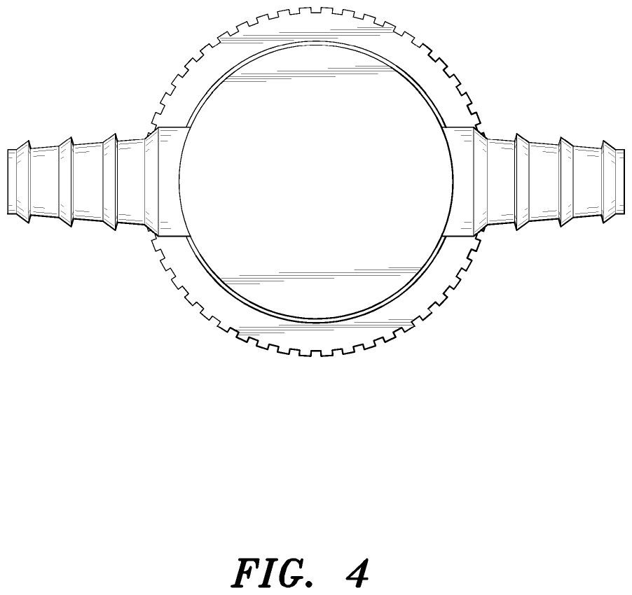

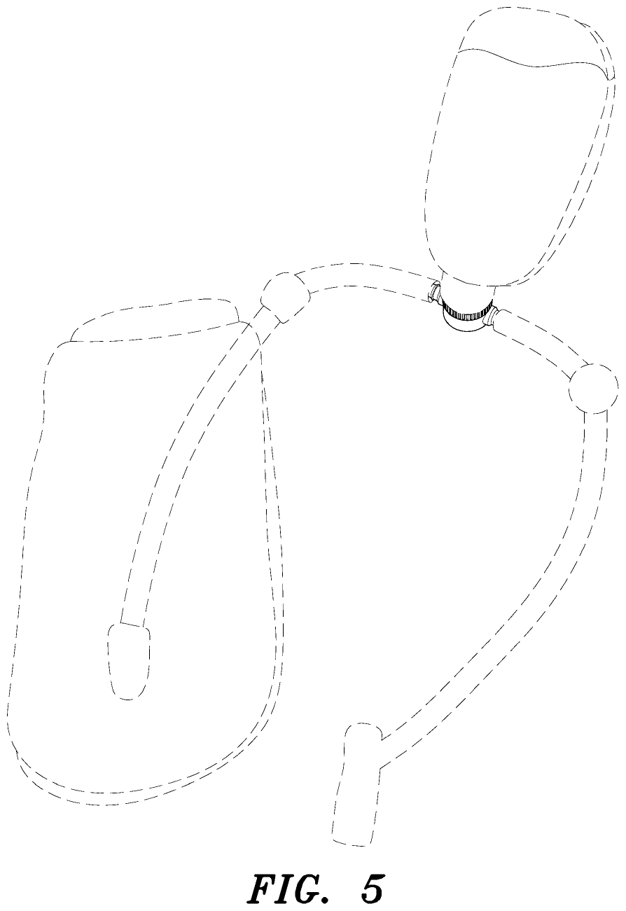

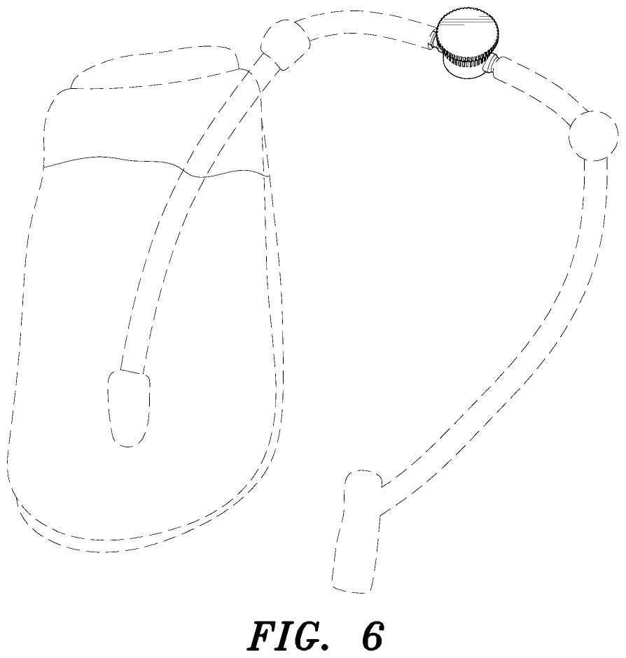

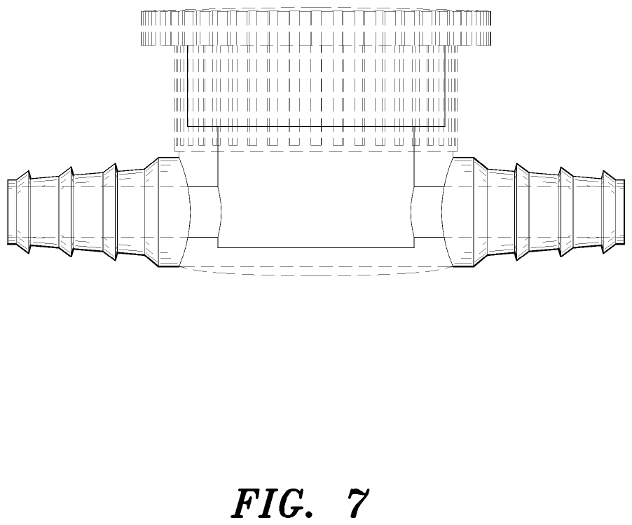

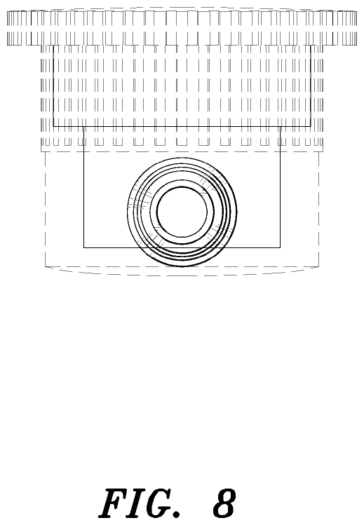

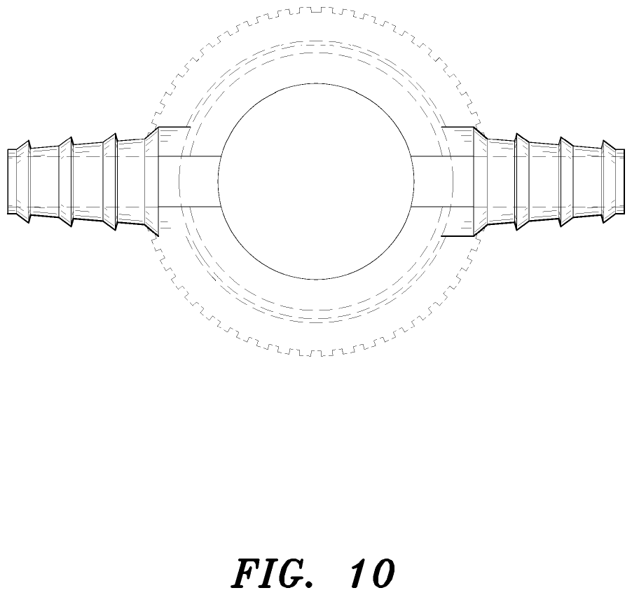

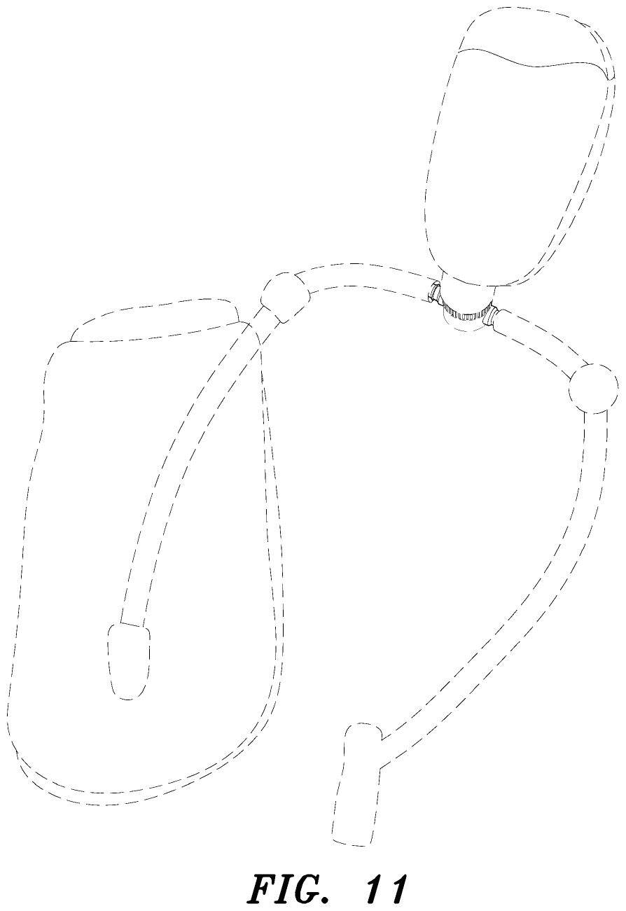

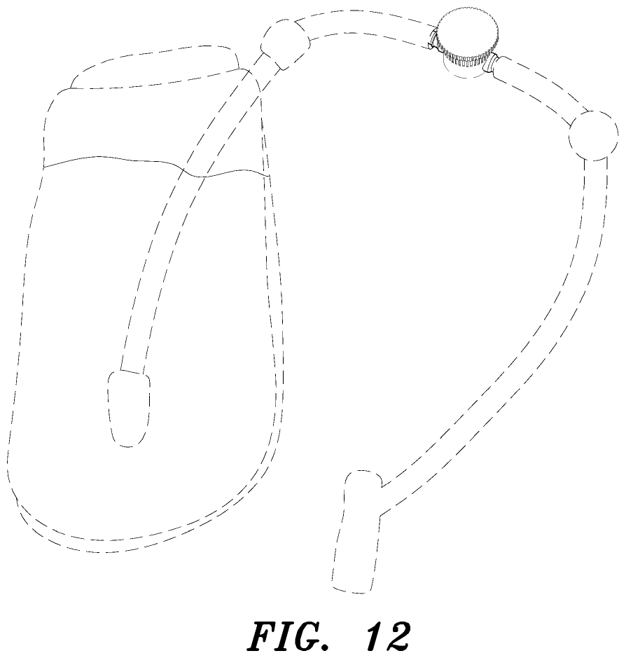

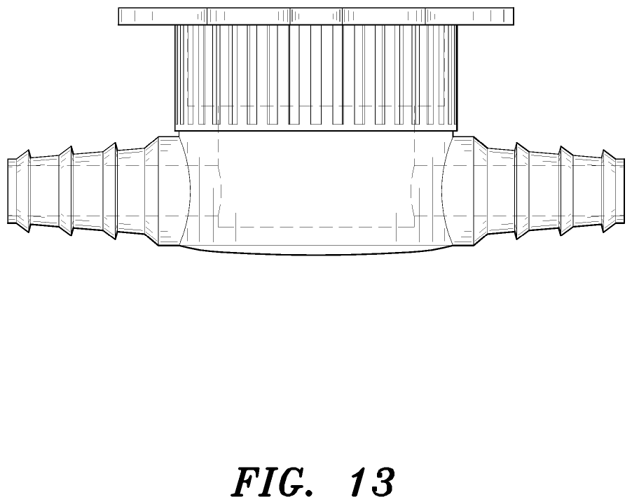

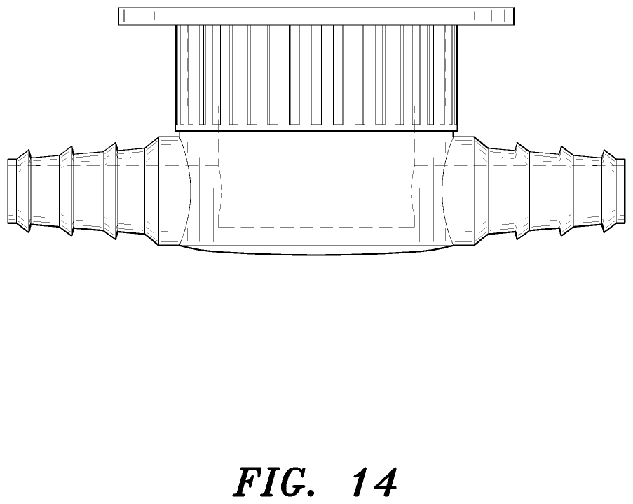

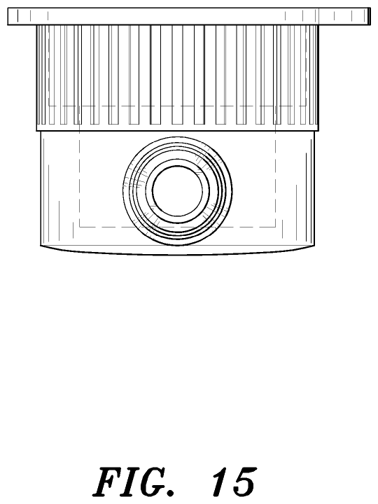

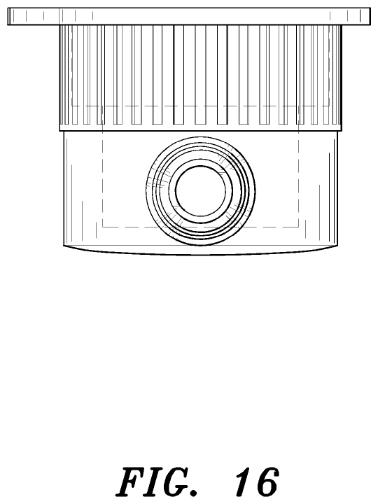

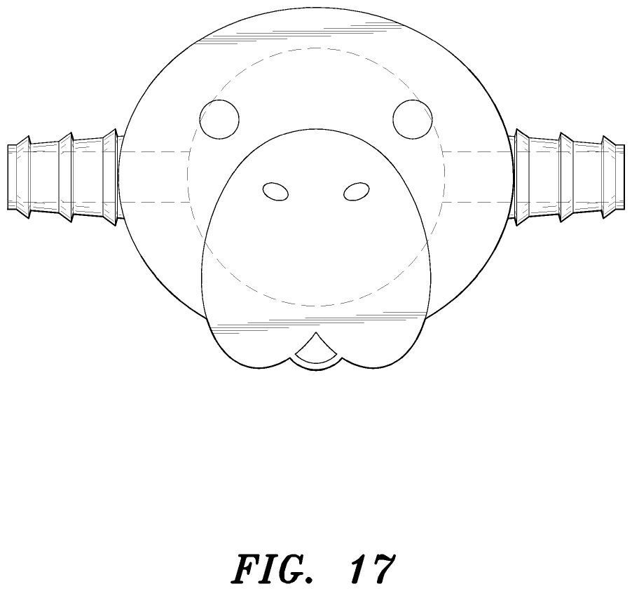

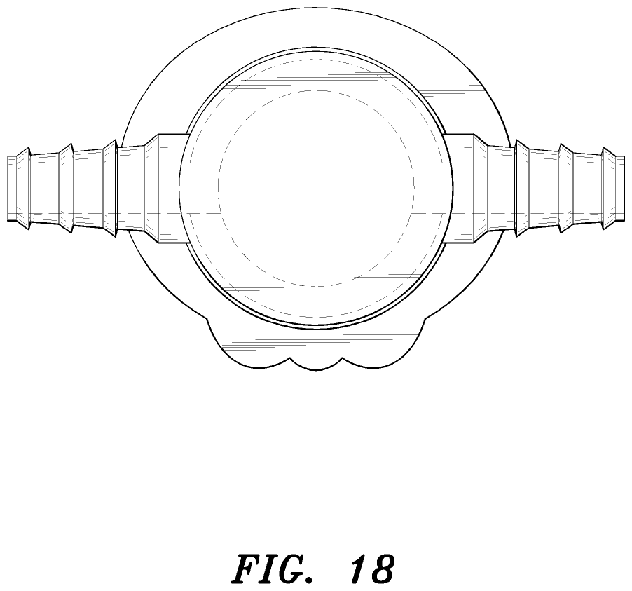

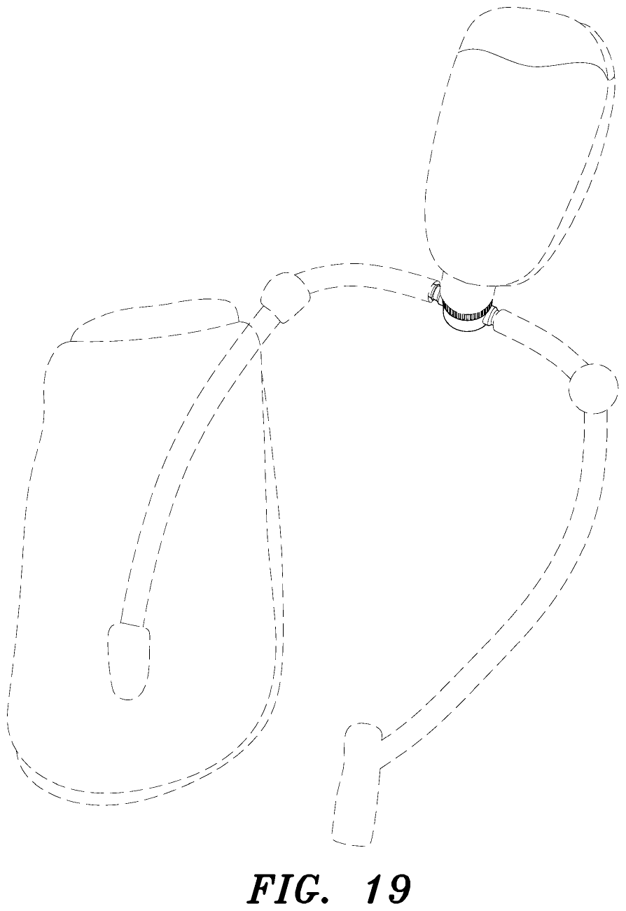

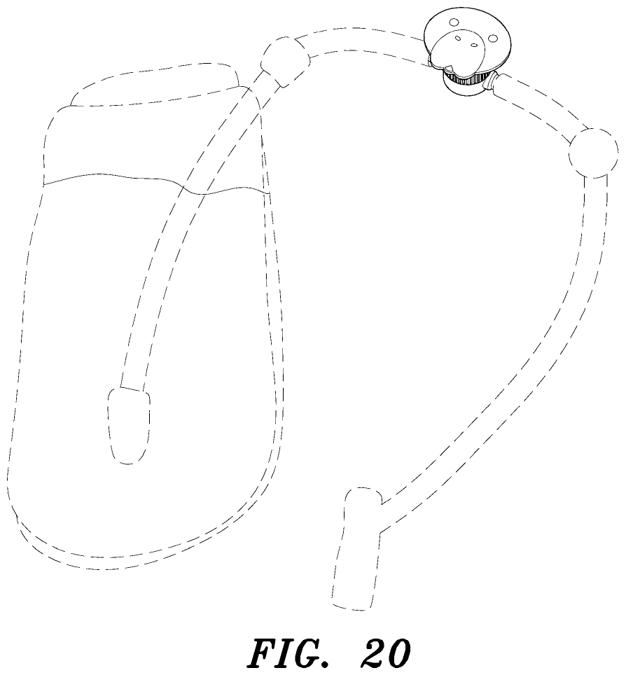

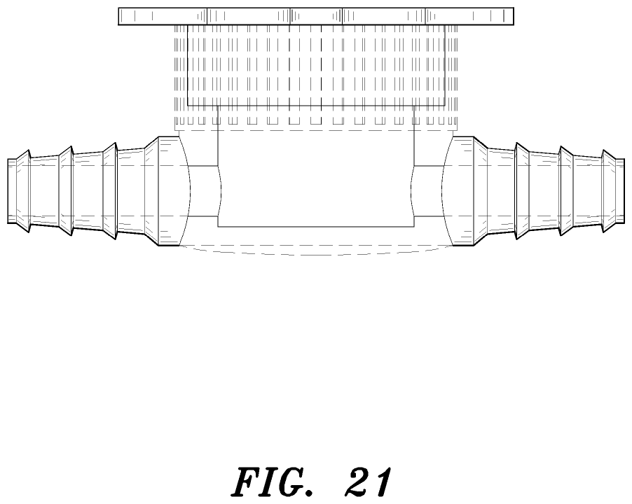

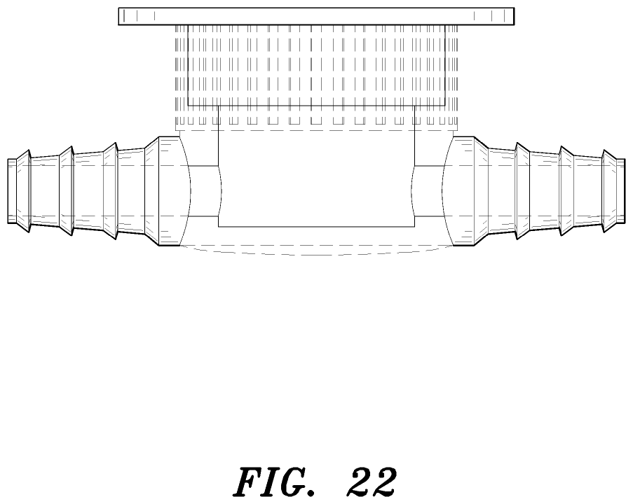

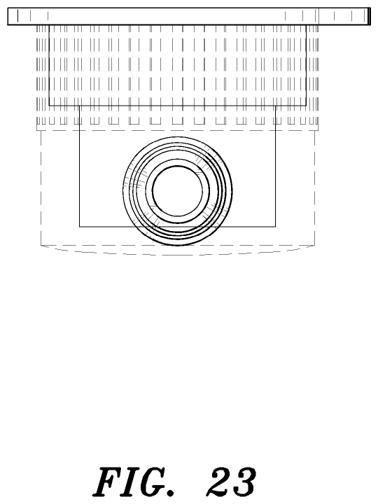

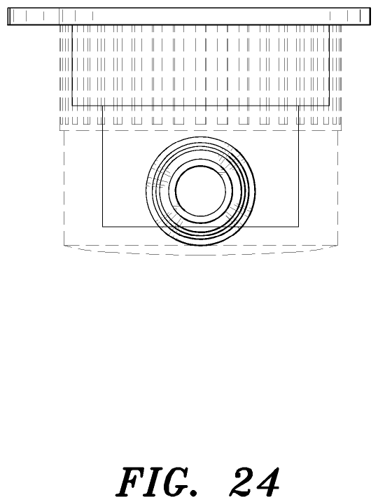

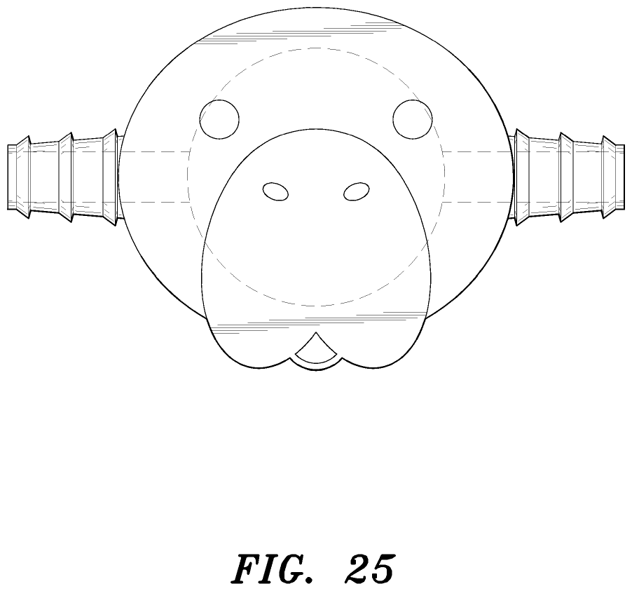

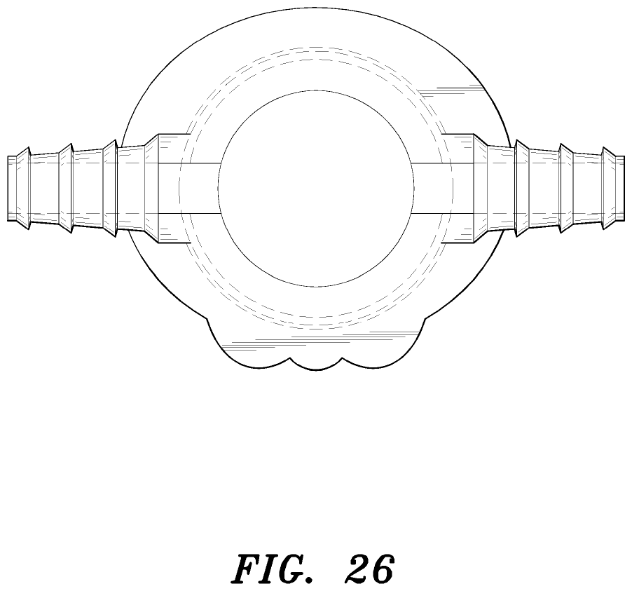

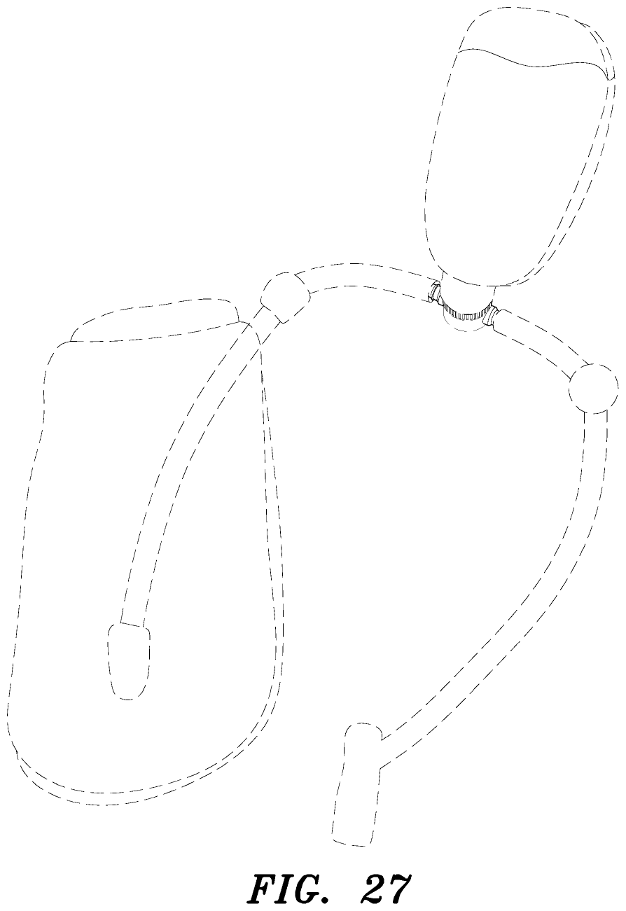

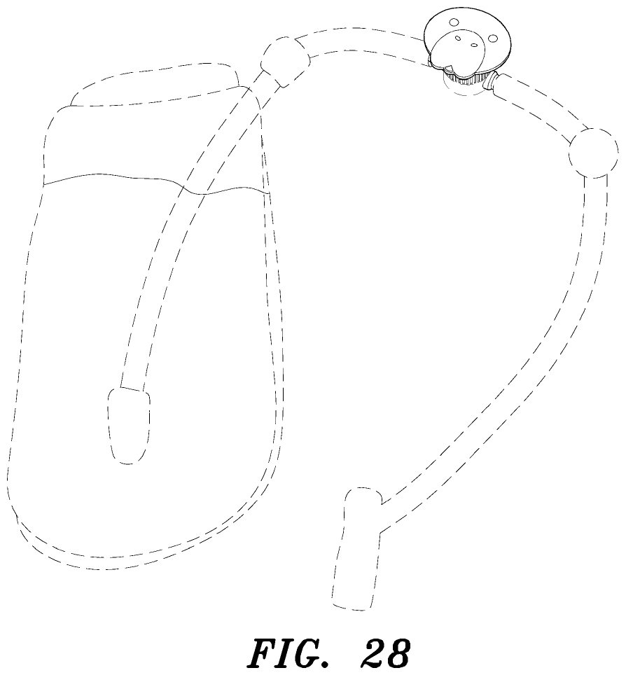

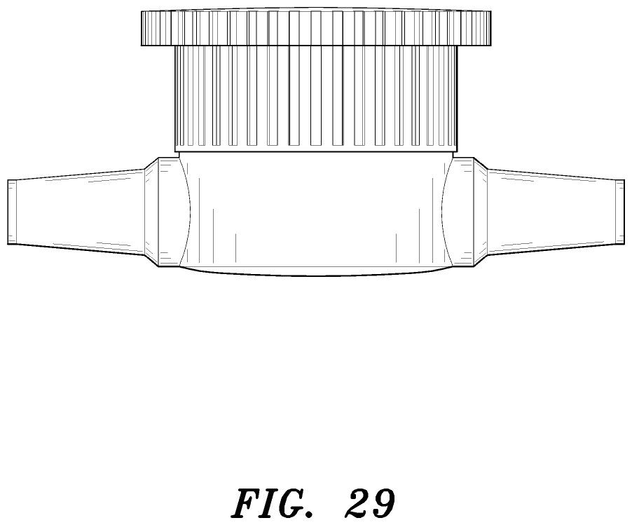

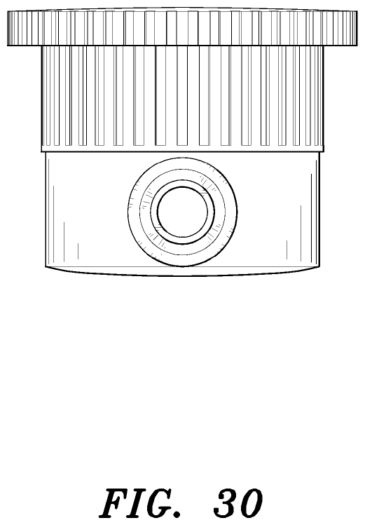

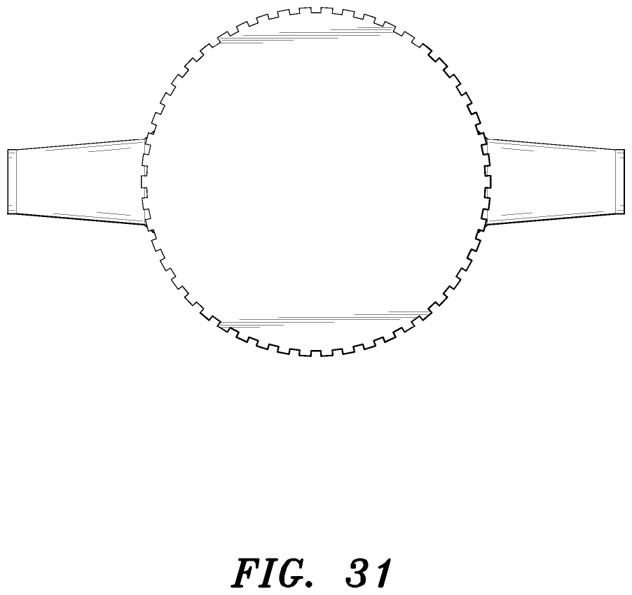

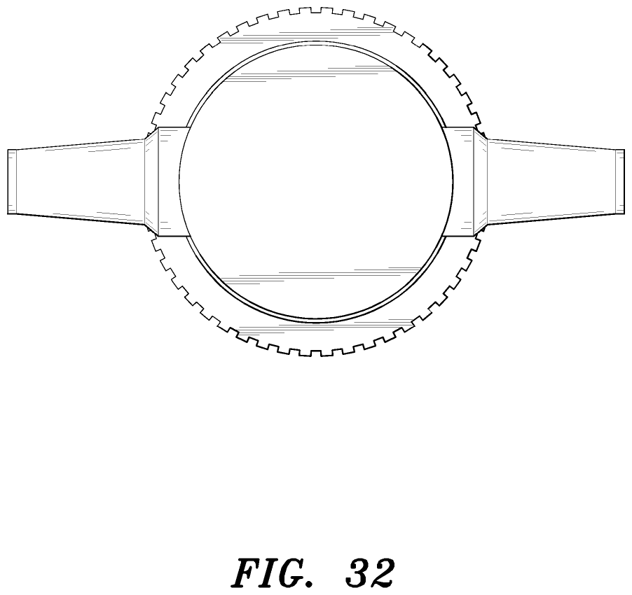

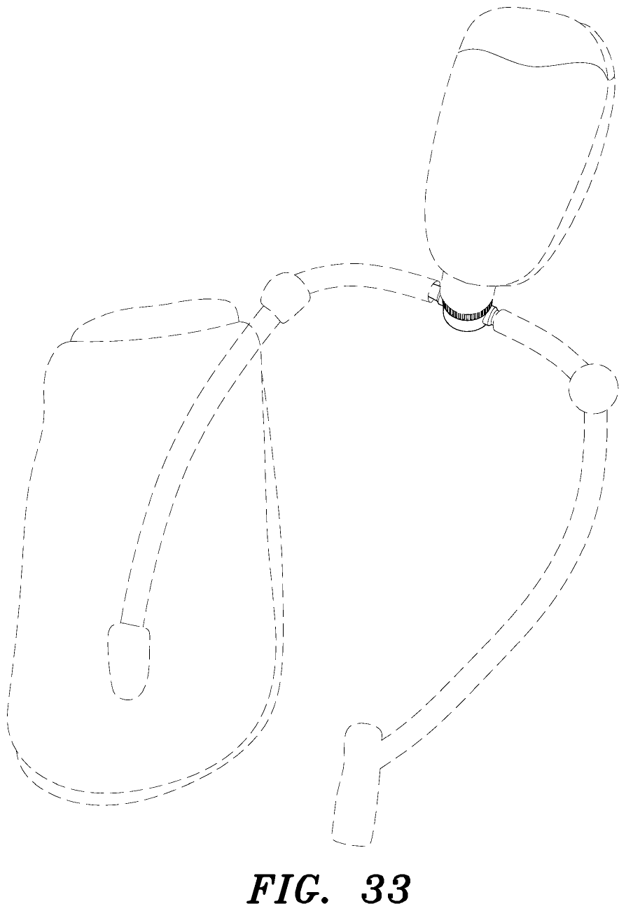

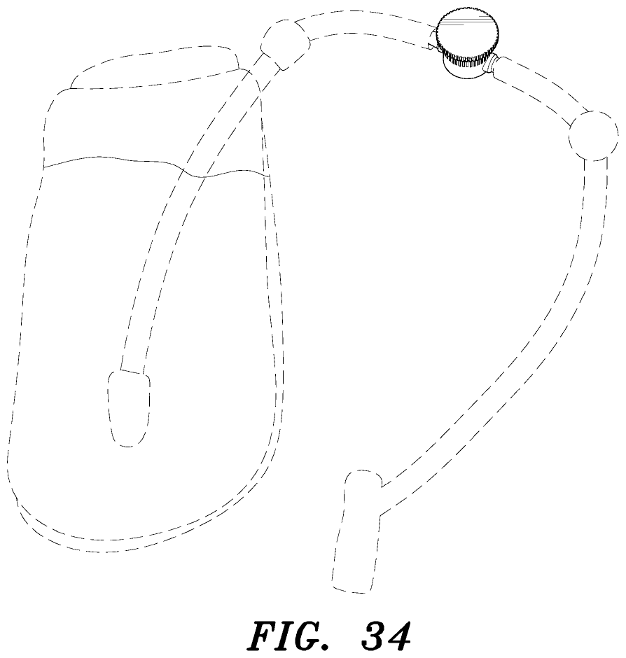

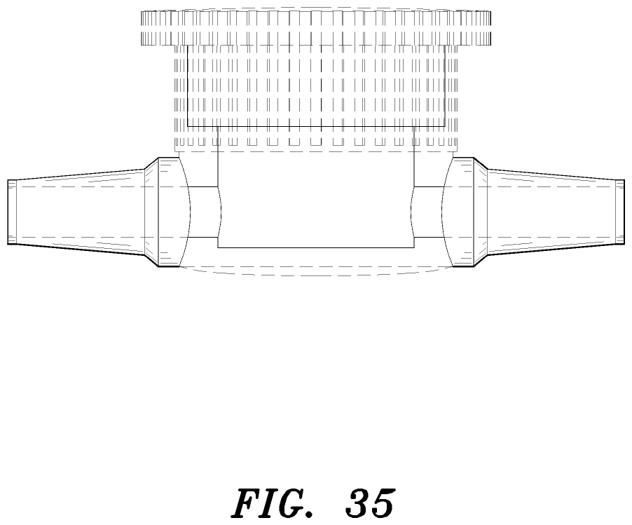

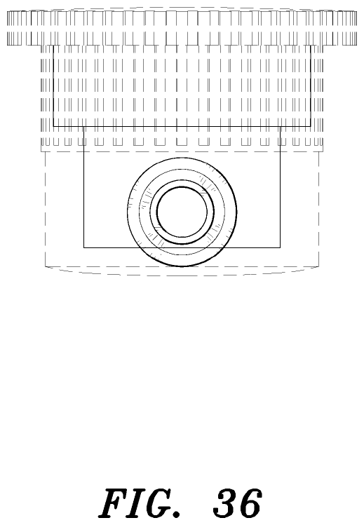

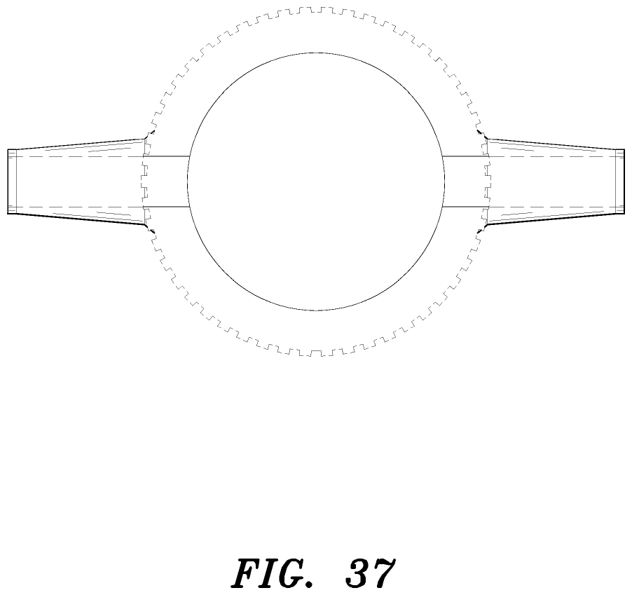

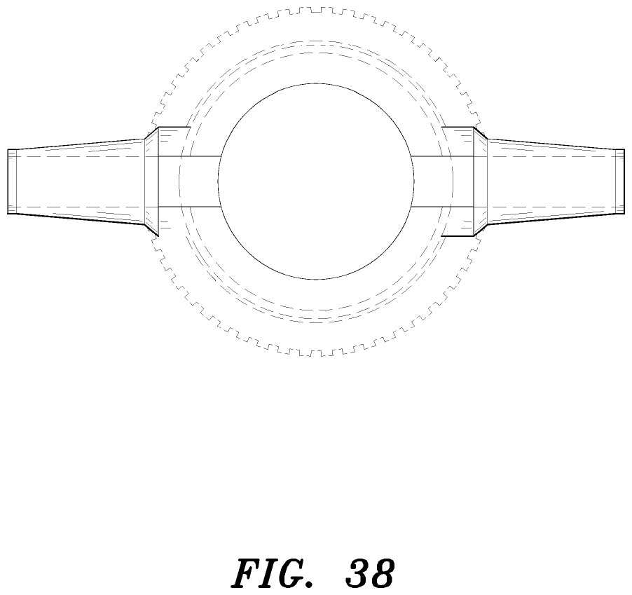

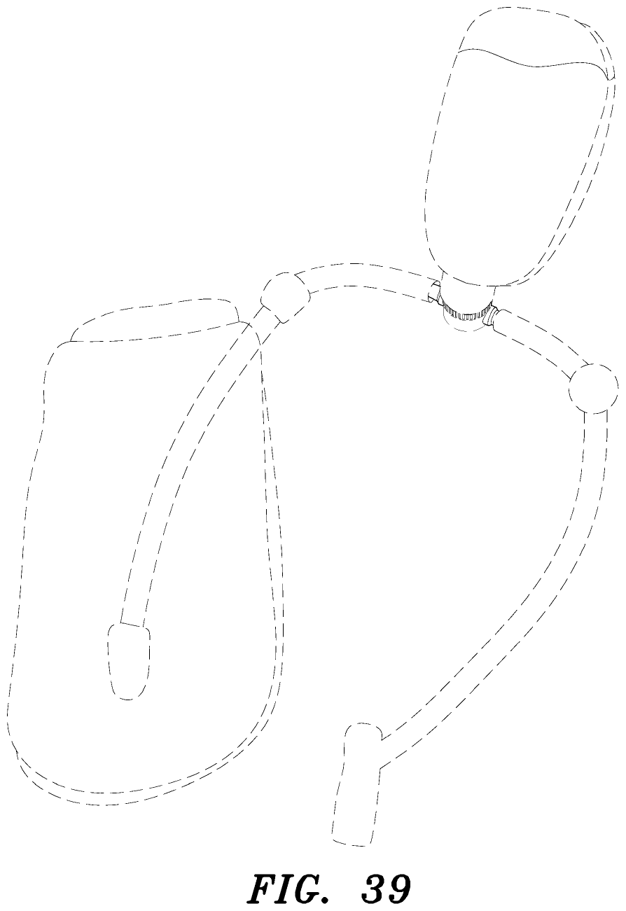

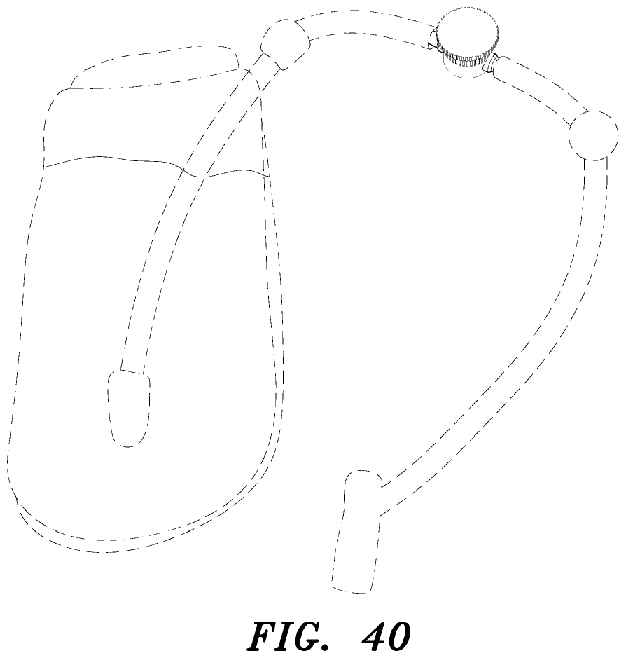

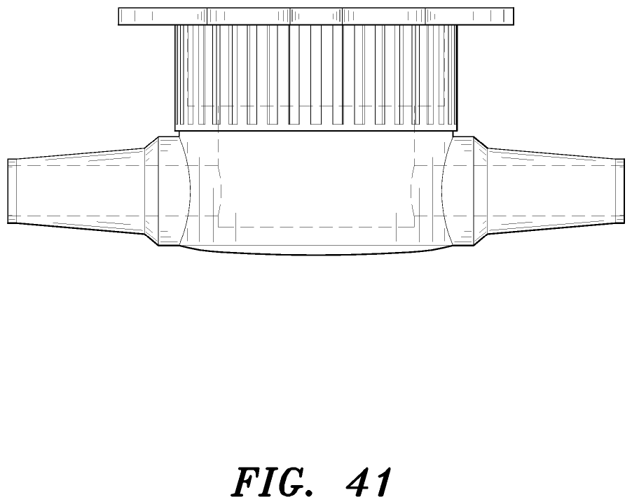

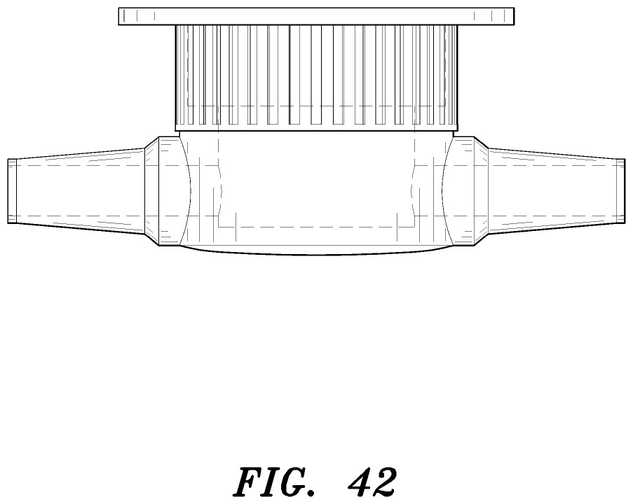

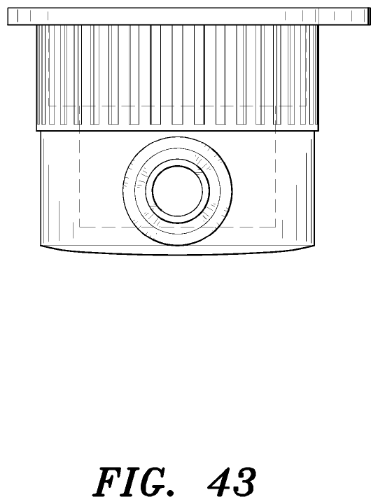

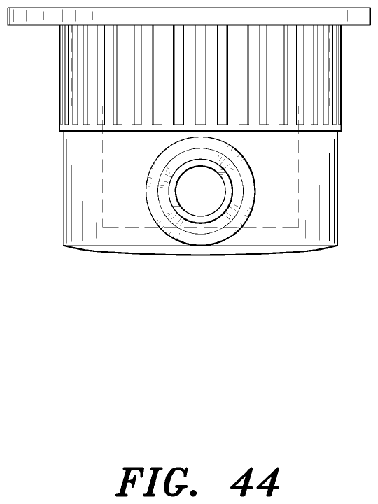

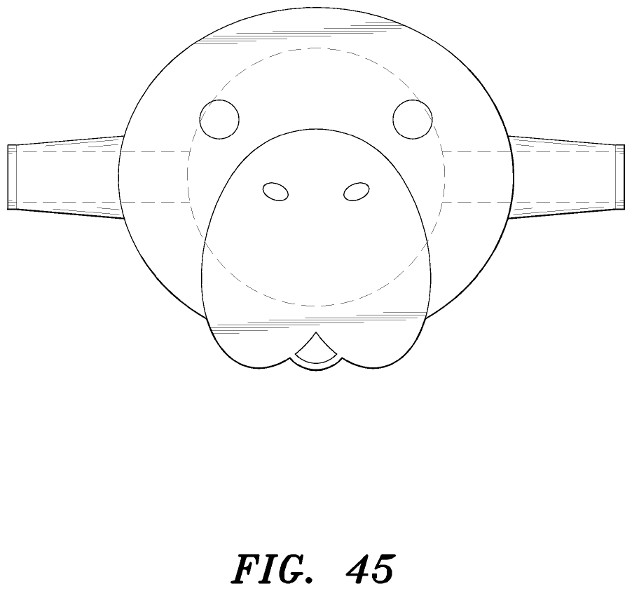

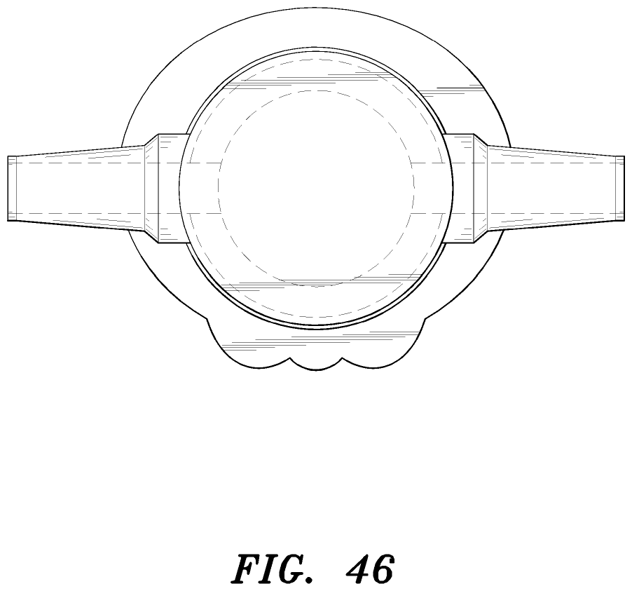

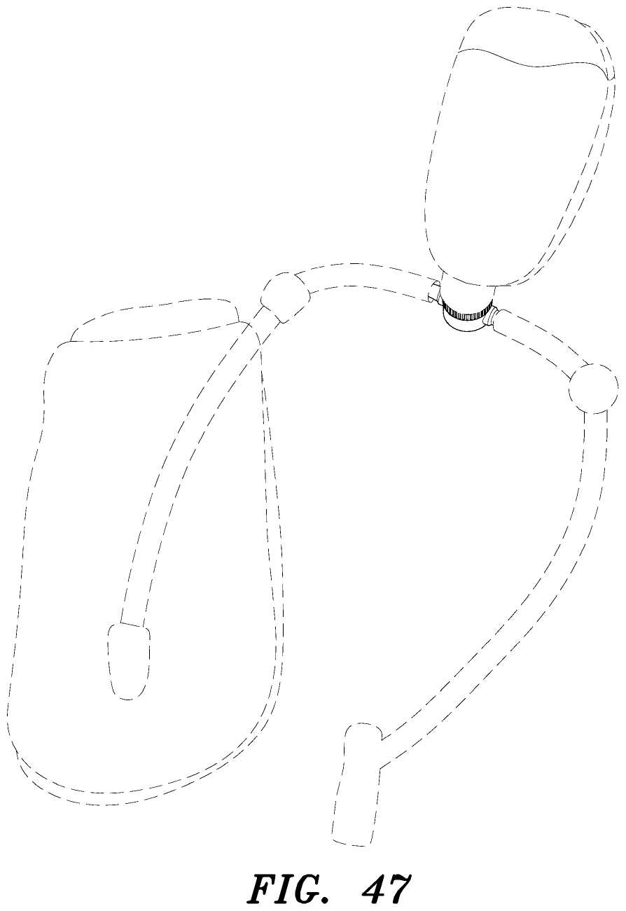

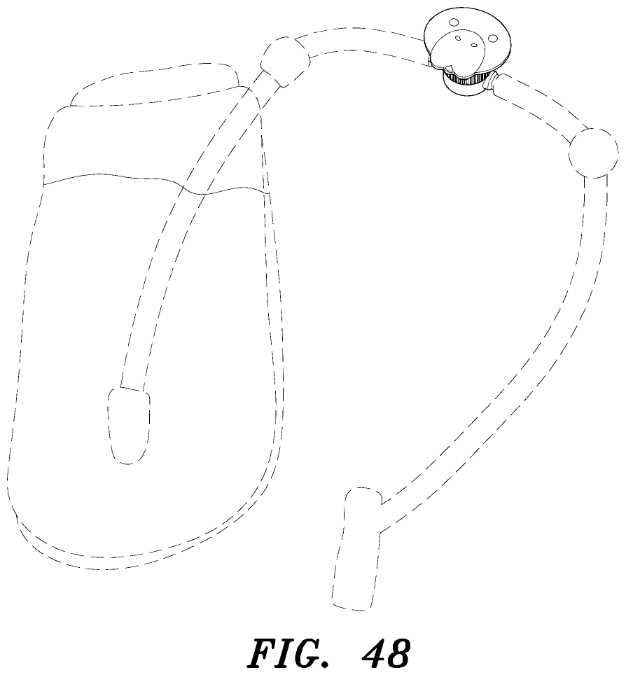

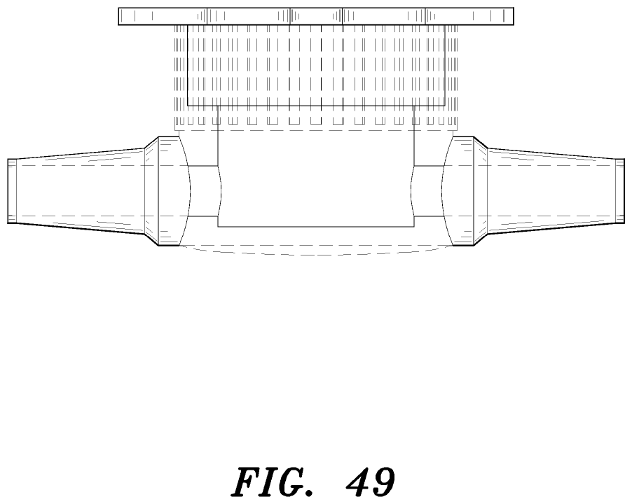

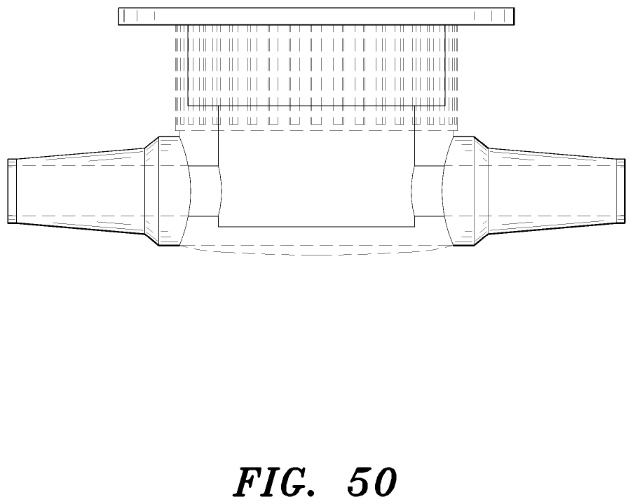

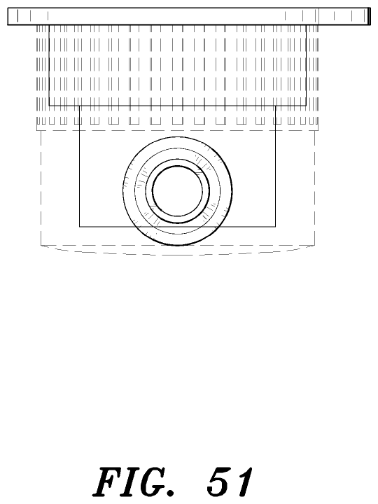

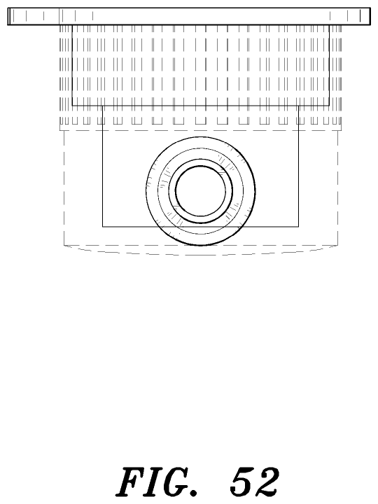

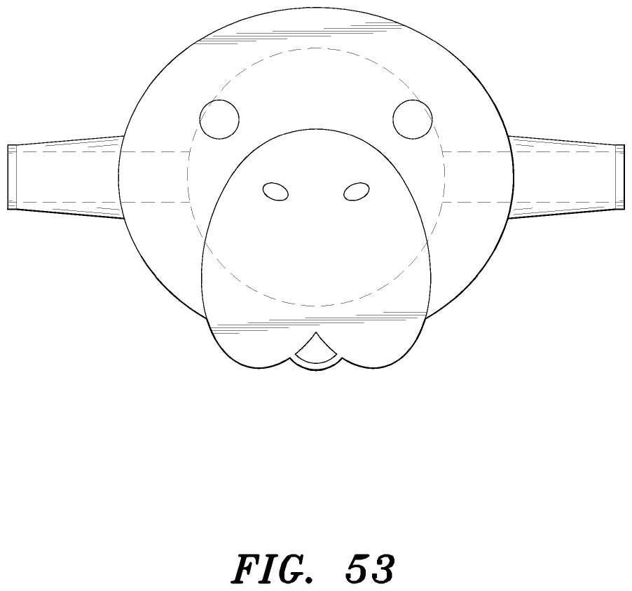

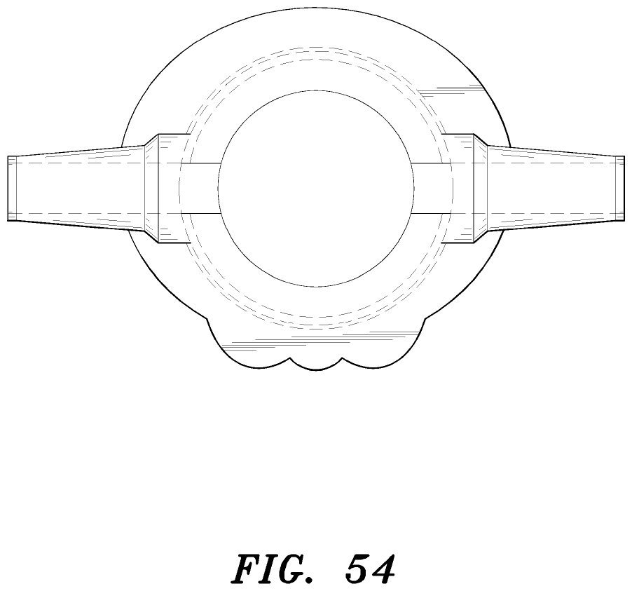

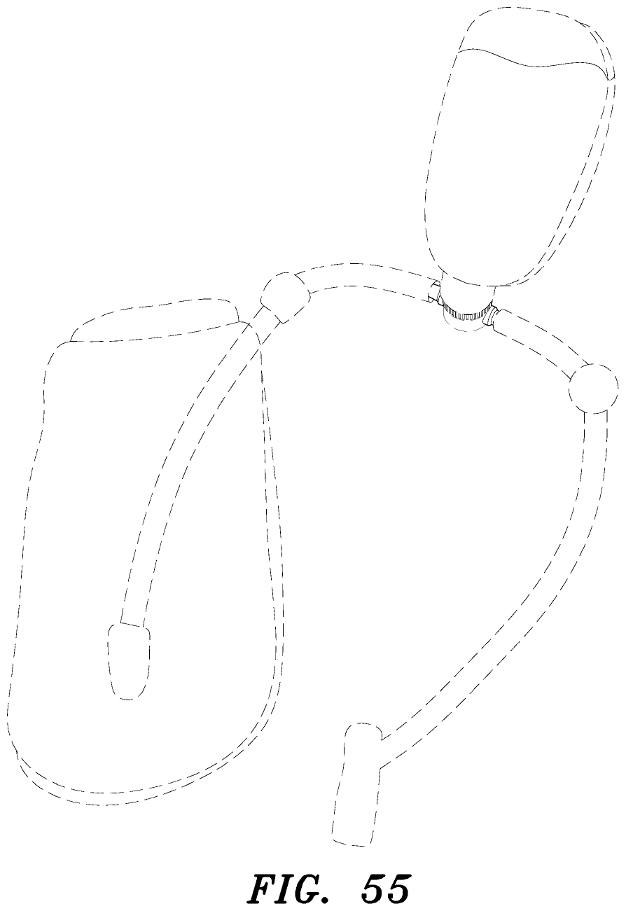

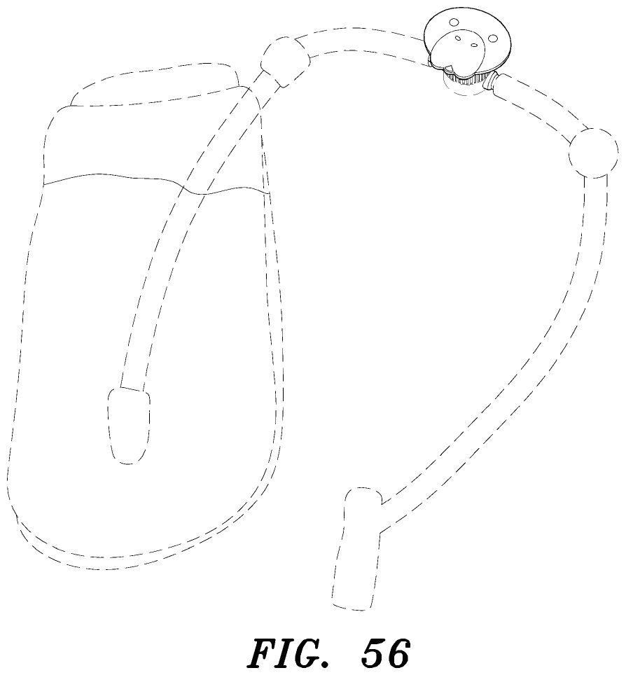

FIGS. 1-56 . . .

It should be understood that the drawings or figures of this pending application are not intended to limit the scope of the present invention in any way.

### DETAILED DESCRIPTION OF PREFERRED EMBODIMENTS

Referring to FIGS. 1-18, illustrative embodiments 100,100b of the filling device can be seen. The filling device 100,100b is intended for allowing a hydration bladder (such as hydration bladder 202 described in this application) to be filled, or for allowing water to be added to the hydration bladder 202, without the need for removing the hydration bladder 202 from a backpack (not shown) in which the hydration bladder 202 is typically carried, dismounting the backpack from the back of a person (not shown) using or carrying the hydration bladder 202 and backpack in some cases, or even opening the backpack to expose the hydration bladder 202 in some cases.

Alternatively, the filling device 100,100b may be used for allowing other water or fluid bladders, receptacles, container, and the like to be filled, or for allowing water or fluid to be added to the water or fluid bladders, receptacles, container, and the like.

The filling device 100,100b is configured for filling or adding water to a bladder. As a non-limiting example, the bladder may be a hydration bladder 202 of a type that is carried on a person, usually inside a backpack, during hiking or other outdoor activities for supplying drinking water on demand to the person. The filling device 100,100b comprises a container 102, a first tubular attachment 104, a second tubular attachment 106, and a closure or cap 108,108b. The container 102 comprises a bottom 110, an open top 112, and a surrounding wall 114 extending between the bottom 110 and the open top 112. The container 102 has an interior 116 and an exterior 118. The surrounding wall 114 has an interior surface 120 and an exterior surface 122. The container 102 has a threaded portion 124 near the open top 112. In the illustrated embodiment, the surrounding wall 114 is annular in cross section and the exterior surface 122 of the surrounding wall 114 is generally cylindrical, and in turn the container 102 is generally cylindrical.

The first tubular attachment 104 has an outer end 126, an outer end opening 128, a bore 130, an inner end 132, and an inner end opening 134, and is attached to the container 102 near the bottom 110 of the container 102. The bore 130 of the first tubular attachment 104 is in fluid communication with the interior 116 of the container 102 so as to provide a first fluid path extending between the outer end opening 128 of the first tubular attachment 104 and the interior 116 of the container 102 such that fluid can travel through the outer end opening 128 of the first tubular attachment 104 and between the outer end opening 128 of the first tubular attachment 104 and the interior 116 of the container 102. The first fluid path extends through the bore 130 of the first tubular attachment 104 and through the inner end opening 134 of the first tubular attachment 104.

The second tubular attachment 106 has an outer end 136, an outer end opening 138, a bore 140, an inner end 142, and an inner end opening 144, and is attached to the container 102 near the bottom 110 of the container 102. The bore 140 of the second tubular attachment 106 is in fluid communication with the interior 116 of the container 102 so as to provide a second fluid path extending between the outer end opening 138 of the second tubular attachment 106 and the interior 116 of the container 102 such that fluid can travel through the outer end opening 138 of the second tubular attachment 106 and between the outer end opening 138 of the second tubular attachment 106 and the interior 116 of the container 102. The second fluid path extends through the bore 140 of the second tubular attachment 106 and through the inner end opening 144 of the second tubular attachment 106. In the illustrated embodiment, the first tubular attachment 104 and the second tubular attachment 106 are attached to the container 102 on opposite sides of the container 102, and the bore 130 of the first tubular attachment 104 and the bore 140 of the second tubular attachment 106 are in line with one another.

In the illustrated example, the interior 116 of the container 102 is free from impediments to the free flow of fluid through the interior 116 of the container 102 and to the bore 130 of the first tubular attachment 104 and to the bore 140 of the second tubular attachment 106. The first tubular attachment 104 and the second tubular attachment 106 are preferably rigid. Each of the first tubular attachment 104 and the second tubular attachment 106 is attached to the container 102 at about its inner end 132 and 142, respectively. Each of the first tubular attachment 104 and the second tubular attachment 106 is attached to the container 102 near the bottom 110 of the container 102. Each of the first tubular attachment 104 and the second tubular attachment 106 at least in part projects outward from the exterior 118 of the container 102. In the illustrated example, each of the first tubular attachment 104 and the second tubular attachment 106 is of one-piece construction with the container 102. In the illustrated example, each of the first tubular attachment 104 and the second tubular attachment 106 is annular in cross section.

The first tubular attachment 104 has an exterior surface 146, and the second tubular attachment 106 has an exterior surface 148. The exterior surface 146 of the first tubular attachment 104 is provided with one or more barbs, ridges, or ribs 150 configured to provide for secure and sealing engagement with an end of a hose. The exterior surface 148 of the second tubular attachment 106 is provided with one or more barbs, ridges, or ribs 152 configured to provide for secure and sealing engagement with an end of a hose. In the illustrated embodiment, the exterior surface 146 of the first tubular attachment 104 is provided with a plurality of barbs, ridges, or ribs 150 distributed along the length of the first tubular attachment 104, and the exterior surface 148 of the second tubular attachment 106 is provided with a plurality of barbs, ridges, or ribs 152 distributed along the length of the second tubular attachment 106. The plurality of barbs, ridges, or ribs 150 and 152 are configured to provide for secure and sealing engagement of the corresponding one of the first tubular attachment 104 and the second tubular attachment 106 with an end of a hose. In the illustrated embodiment, each of the plurality of barbs, ridges, or ribs 150 and 152 is annular. The first tubular attachment 104 and the second tubular attachment 106 are tapered such that they have a larger diameter at their inner end 132,142 compared to the diameter at their outer ends 126,136. Accordingly, the first tubular attachment 104 and the second tubular attachment 106 are configured for secure and sealed or water-tight engagement with hose ends of a plurality of sizes, such as, but not limited to, a quarter inch, three eighths inch, and one half inch hose sizes in diameter. The first tubular attachment 104, the second tubular attachment 106, and the hoses may be dimensioned to various larger sizes to accommodate greater fluid flow into and out of the hydration bladder 202. In the illustrated example, the exterior surfaces 146 and 148 of the first and second tubular attachments 104 and 106 are provided with pluralities of barbs 150 and 152, respectively.

Preferably, the screw thread 154 of the threaded portion 124 of the container 102 is of a standard type that is configured to be capable of threaded engagement with a screw thread of a filtered water outlet 156 of at least one preexisting, currently commercially available water filtration system 158, or a screw thread of a water outlet of a preexisting, currently commercially available water bottle (not shown) or other water supply container (not shown), to provide for secure, water-tight fluid communication and engagement between the interior 116 of the container 102 and the filtered water outlet 156 of the water filtration system 158 or the water outlet of the water bottle or the water outlet of the other water supply container. Accordingly, the water filtration system 158, the water bottle, or the other water supply container can be used to replenish or add water W to the hydration bladder 202.

In the illustrated embodiment, the screw thread 154 of the threaded portion 124 of the container 102 is of a standard type that is configured to be capable of threaded engagement with a screw thread of a filtered water outlet 156 of a plurality of preexisting, currently commercially available water filtration systems 158 to provide for secure, water-tight fluid communication and engagement between the interior 116 of the container 102 and the filtered water outlet 156 of each of the plurality of water filtration systems 158. In addition, the screw thread 154 of the threaded portion 124 of the container 102 is of a standard type that is configured to be capable of threaded engagement with a screw thread of a filtered water outlet of a plurality of preexisting, currently commercially available water supply containers, including standard water bottles for example, to provide for secure, water-tight fluid communication and engagement between the interior 116 of the container 102 and the water outlet of each of the plurality of water supply containers. Examples of preexisting, currently commercially available water filtration systems 158 include, without limitation, any industry standard water filter commonly used by backpackers to purify stream water to be used for human consumption and include filtration systems such as the SAWYER® SQUEEZE and the KATADYN® BEFREE. The water filtration system 158 may in turn be supplied with stream water from an included or compatible water supply container 192. Examples of preexisting, currently commercially available water supply containers include, without limitation, any industry standard drinking water bottle such as those that are commonly purchased from stores.

In the illustrated embodiment, the bottom 110 of the container 102 is closed off by a circular bottom plate 160. The bottom plate 160 has an interior surface 162 and an exterior surface 161. The interior surface 162 of the bottom plate 160 provides a bottom surface of the interior 116 of the container 102. The inner end opening 134 of the first tubular attachment 104 is located at or near the bottom surface 162 of the interior 116 of the container 102. The inner end opening 144 of the second tubular attachment 106 is located at or near the bottom surface 162 of the interior 116 of the container 102 on an opposite side of the surrounding wall 114 of the container 102 relative to the inner end opening 134 of the first tubular attachment 104. The inner end 132 of the first tubular attachment 104 may extend through the surrounding wall 114 of the container 102 such that the inner end opening 134 of the first tubular attachment 104 is located on the interior surface 120 of the surrounding wall 114. Similarly, inner end 142 of the second tubular attachment 106 may extend through the surrounding wall 114 of the container 102 such that the inner end opening 144 of the second tubular attachment 106 is located on the interior surface 120 of the surrounding wall 114. Alternatively, the surrounding wall 114 may have a first bore through it that is coaxial with the bore 130 of the first tubular attachment 104 for allowing fluid communication between the bore 130 of the first tubular attachment 104 and the interior 116 of the container 102, and the surrounding wall 114 may have a second bore through it that is coaxial with the bore 140 of the second tubular attachment 106 for allowing fluid communication between the bore 140 of the second tubular attachment 106 and the interior 116 of the container 102.

In the illustrated embodiment, the first tubular attachment 104 and the second tubular attachment 106 are attached to the container 102 at or near the bottom 110 of the container 102. The first tubular attachment 104 and the second tubular attachment 106 extend outward from the exterior 118 of the container 102 in opposite directions that are transverse to the longitudinal axis of the container 102. The inner end opening 134 of the first tubular attachment 104 and the inner end opening 144 of the second tubular attachment 106 are located between the threaded portion 124 of the container 102 and the bottom 110 of the container 102.

In the illustrated embodiment, the open top 112 of the container 102 has a rim 164. The threaded portion 124 of the container 102 comprises a female thread 154 provided on the interior surface 120 of the surrounding wall 114. A portion 166 of the surrounding wall 114 located between the threaded portion 124 of the container 102 and the bottom 110 of the container 102 is of increased wall thickness to form an abutment 168 on the interior 116 of the container 102 to act as a stop for the filtered water outlet 156 of the water filtration system 158, or the water outlet of the water bottle or the water supply container, to abut against when the filtered water outlet 156 of the water filtration system 158, or the water outlet of the water bottle or the water supply container, is fully tightened into the threaded portion 124 of the container 102 in cases where the filtered water outlet 156 of the water filtration system 158, or the water outlet of the water bottle or the water supply container, lacks a properly located flange or other abutting surface capable of abutting the rim 164 of the open top 112 of the container 102 to stop the filtered water outlet 156 of the water filtration system 158, or the water outlet of the water bottle or the water supply container, from excessive ingress or penetration into the container 102. The inner end opening 134 of the first tubular attachment 104 and the inner end opening 144 of the second tubular attachment 106 are located between the abutment 168 and the bottom 110 of the container 102.

In the illustrative embodiment, the inner end 132 of the first tubular attachment 104 may extend through the thicker wall portion 166 of the surrounding wall 114 of the container 102 such that the inner end opening 134 of the first tubular attachment 104 is located on the portion of the interior surface 120 of the surrounding wall 114 corresponding to the thicker wall portion 166. Similarly, inner end 142 of the second tubular attachment 106 may extend through the thicker wall portion 166 of the surrounding wall 114 of the container 102 such that the inner end opening 144 of the second tubular attachment 106 is located on the portion of the interior surface 120 of the surrounding wall 114 corresponding to the thicker wall portion 166. Alternatively, the thicker wall portion 166 of the surrounding wall 114 may have a first bore through it that is coaxial with the bore 130 of the first tubular attachment 104 for allowing fluid communication between the bore 130 of the first tubular attachment 104 and the interior 116 of the container 102, and the thicker wall portion 166 of the surrounding wall 114 may have a second bore through it that is coaxial with the bore 140 of the second tubular attachment 106 for allowing fluid communication between the bore 140 of the second tubular attachment 106 and the interior 116 of the container 102.

In the illustrated embodiment, the portion 166 of the surrounding wall 114 that is of the increased wall thickness extends from the abutment 168 to the bottom 110 of the container 102 over the entire extent of the perimeter of the bottom surface 162 of the container 102 such that the abutment 168 is in the form of an annular step in the interior 116 of the container 102.

In some embodiments herein, a portion 170 of the exterior 118 of the container 102 adjacent or near the open top 112 of the container 102 is provided with a surface structure 172 that affords a better grip to a user to help the user to resist or apply torque to achieve threaded engagement between the container 102 and other objects such as the closure or cap 108,108b or the filtered water outlet 156 of the water filtration system 158, which are provided as non-limiting examples. The surface structure 172 may be selected from the group consisting of:

a) longitudinal, i.e. extending from the open top 112 of the container 102 in the direction of the bottom 110 of the container 102, ribs evenly distributed about the outer perimeter of the surrounding wall 114,

b) longitudinal ridges evenly distributed about the outer perimeter of the surrounding wall 114,

c) longitudinal grooves or troughs evenly distributed about the outer perimeter of the surrounding wall 114,

d) longitudinal serrations evenly distributed about the outer perimeter of the surrounding wall 114,

e) a pattern of stippling distributed about the outer perimeter of the surrounding wall 114,

f) knurling distributed over the outer perimeter of the surrounding wall 114,

g) a pattern of projections distributed over the outer perimeter of the surrounding wall 114, and

h) an array of teeth distributed over the outer perimeter of the surrounding wall 114.

In the illustrative example, the surface structure 172 is provided by longitudinal ribs evenly distributed about the outer perimeter of the surrounding wall 114.

In the embodiments herein, the filling device 100,100b may further comprise a closure or cap 108,108b for the open top 112 of the container 102 for securely closing off the open top 112 of the container 102 when the filling device 100,100b is not being used to add fluid to the hydration bladder 202. When the closure or cap 108,108b is used to securely close and seal off the open top 112 of the container 102, the fluid path from the hydration bladder 202 to the mouthpiece 208 is sealed off from the atmosphere such that a user can suck water from the hydration bladder 202 and into his or her mouth through the first hose section 204, the filling device 100,100b, the second hose section 206 and the mouthpiece 208. In the illustrated embodiment, the closure or cap 108,108b comprises a cap plate 174,174b and a threaded plug 176. The a cap plate 174,174b has a circumference, an outer diameter, a top surface 178,178b, a bottom surface 180,180b, and a circumferential surface 182,182b extending between the top surface 178,178b of the cap plate 174,174b and the bottom surface 180,180b of the cap plate 174,174b and along the circumference of the cap plate 174,174b. The threaded plug 176 has a screw thread 184 configured for mating engagement with the threaded portion 124 of the container 102. The threaded plug 176 extends out from the bottom surface 180,180b of the cap plate 174,174b. The threaded plug 176 has an outer diameter that is smaller than the outer diameter of the cap plate 174,174b. In the illustrated example, the screw thread 184 of the threaded plug 176 is a male screw thread. The closure or cap 108,108b may be designed such that the bottom of the threaded plug 176 contacts and seals against the abutment or step 168 to stop further ingress of the plug 176, and in turn of the closure or cap 108,108b, into the container 102 and to seal off the interior of the container 102 from the atmosphere; or the closure or cap 108,108b may be designed such that the bottom of the cap plate 174,174b contacts and seals against the rim 164 of the open top 112 of the container 102 to stop further ingress of the plug 176, and in turn of the closure or cap 108,108b, into the container 102 and to seal off the interior of the container 102 from the atmosphere. A combination of these designs may also be employed. Preferably, the diameter of the cap 108,108b is greater than the diameter of the top of the container 102 so that the user can have a better grip to secure the cap 108,108b to the container 102 and, alternatively, to unsecure the cap 108,108b from the container 102.

In some embodiments herein and as shown in FIGS. 11-18, a decorative design in the form of a relief 186 is incorporated into the cap plate 174b on the top surface 178b and the circumferential surface 182b of the cap plate 174b. A portion 188 of the relief 186 protrudes outward beyond the circumference of the cap plate 174b to provide a better purchase to a user for applying torque to the closure or cap 108b for unscrewing or tightening the closure or cap 108b on the open top 112 of the container 102. In the illustrated embodiment, the relief 186 is a stylized or cartoon depiction of a manatee.

In some embodiments herein, the circumferential surface 182b is provided with a surface structure 190b that affords a better grip to a user to help the user to resist or apply torque to the closure or cap 108b for unscrewing or tightening the closure or cap 108b on the open top 112 of the container 102. The surface structure 190b may be selected from the group consisting of:

a) axial, i.e. extending between the top surface 178b and the bottom surface 180b of the cap plate 174b, ribs evenly distributed about the outer perimeter of the cap plate 174b,

b) axial ridges evenly distributed about the outer perimeter of the cap plate 174b, c) axial grooves or troughs evenly distributed about the outer perimeter of the cap plate 174b,

d) axial serrations evenly distributed about the outer perimeter of the cap plate 174b,

e) a pattern of stippling distributed over the circumferential surface 182b of the cap plate 174b,

f) knurling distributed over the circumferential surface 182b of the cap plate 174b,

g) a pattern of projections distributed over the circumferential surface 182b of the cap plate 174b, and

h) an array of teeth distributed over the circumferential surface 182b of the cap plate 174b.

In the illustrative example, the surface structure 190b is provided by axial ridges evenly distributed about the outer perimeter of the cap plate 174b. The filling device 100b is provided with both the surface structure 190b and the lateral projection 188 to afford the user a better grip on the cap plate 174b and in turn on the closure or cap 108.

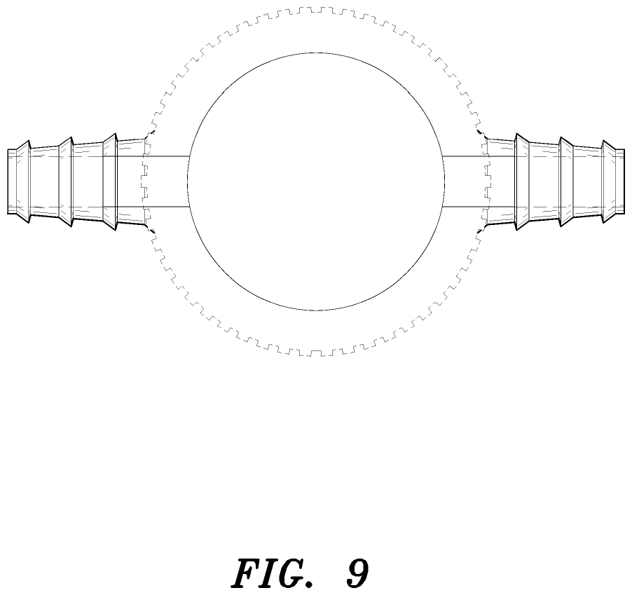

Referring to FIGS. 9-10 and 17-18, some embodiments herein are directed to a hydration device or system 200,200b comprising a filling device in accordance with the embodiments disclosed herein, a hydration bladder 202, a first hose section 204, a second hose section 206, and the mouthpiece 208. As a non-limiting example, the filling device may be the filling device 100,100b. Each of the first hose section 204 and the second hose section 206 may be made of a single piece of hose or of multiple pieces of hose connected together. The hydration bladder 202 is configured for storing a quantity of water and/or fluid(s) and providing water and/or fluid(s) on demand to a user. The hydration bladder 202 has a dispensing outlet 210 configured for attachment of a hose. In the illustrated example, the first hose section 204 is attached or connected to the dispensing outlet 210 of the hydration bladder 202.

The first hose section 204 has a first end portion 212 and a second end portion 214. The first end portion 212 of the first hose section 204 is connected to the dispensing outlet 210 of the hydration bladder 202, and the second end portion 214 of the first hose section 204 is connected to the first tubular attachment 104 of the filling device 100,100b. The first hose section 204 provides for fluid travel between the hydration bladder 202 and the filling device 100,100b.

The second hose section 206 has a first end portion 216 and a second end portion 218. The first end portion 216 of the second hose section 206 is connected to the second tubular attachment 106 of the filling device 100,100b, and the second end portion 218 of the second hose section 206 is connected to the mouthpiece 208. The second hose section 206 provides for fluid travel between the filling device 100,100b and the mouthpiece 208.

The mouthpiece 208 is configured to allow the user to obtain water and/or fluid(s) from the hydration bladder 202 and into their mouth by creating suction in their mouth while having at least a portion of the mouthpiece 208 inserted in their mouth. The open top 112 of the filling device 100,100b is configured for attachment of an outlet 156 of a water filtration system 158, or an outlet of a water supply container, for adding water and/or fluid(s) to the hydration bladder 202. The outlet 156 of the water filtration system 158, or the outlet of the water supply container, can be attached to the open top 112 of the container 102 of the filling device 100,100b for fluid communication between the interior 116 of the container 102 of the filling device 100,100b and the outlet 156 of the water filtration system 158, or the outlet of the water supply container, when the closure or cap 108,108b is removed from the open top 112 of the container 102 of the filling device 100,100b.

An example of a mouthpiece suitable for use with or as part of some of the embodiments herein can be seen in U.S. Pat. No. 9,624,089 B1, issued to Robert Edward Ostrom on Apr. 18, 2017, which is incorporated by reference herein in its entirety. The mouthpiece in Ostrom is of a type referred to as a bite valve.

It should be noted that “approximate” and “approximately” as used herein are understood to encompass within them the exact thing, noun, or adjective that they refer to. Also, “near” as used herein should be understood to mean in close proximity to or at a reference location. The word “about” means the same as the word “near” when referring to location. The terms “end” and “end portion” are used interchangeably herein. The “user” as used herein includes any person engaged in using, manufacturing, assembling, or packaging a device or apparatus or who otherwise may need or wish to employ the referenced feature of the device or apparatus.

The exemplary embodiments disclosed herein are for illustrative purposes only and are not meant to be used to limit the scope of the claims of this pending application. Various modifications of the disclosed embodiments as well as alternatives to these embodiments will become apparent to persons skilled in the art without departing from the scope of the claims. It is therefore contemplated that the claims will cover any and all modifications or embodiments that fall within the fullest scope of the claims under applicable law.

1. A filling device comprising:
a container comprising a bottom, an open top, and a surrounding wall extending between the bottom and the open top, the container having an interior and an exterior, the surrounding wall having an interior surface and an exterior surface, the container having a threaded portion near the open top;
a first tubular attachment having an outer end, an outer end opening, a bore, an inner end, and an inner end opening, the bore of the first tubular attachment being in fluid communication with the interior of the container so as to provide a first fluid path extending between the outer end opening of the first tubular attachment and the interior of the container such that fluid can travel through the outer end opening of the first tubular attachment and between the outer end opening of the first tubular attachment and the interior of the container, the first fluid path extending through the bore of the first tubular attachment and through the inner end opening of the first tubular attachment; and
a second tubular attachment having an outer end, an outer end opening, a bore, an inner end, and an inner end opening, the bore of the second tubular attachment being in fluid communication with the interior of the container so as to provide a second fluid path extending between the outer end opening of the second tubular attachment and the interior of the container such that fluid can travel through the outer end opening of the second tubular attachment and between the outer end opening of the second tubular attachment and the interior of the container, the second fluid path extending through the bore of the second tubular attachment and through the inner end opening of the second tubular attachment.

2. The filling device according to claim 1, wherein the interior of the container is free from impediments to the free flow of fluid through the interior of the container and to the bore of the first tubular attachment and the bore of the second tubular attachment.

3. The filling device according to claim 1, wherein the first tubular attachment and the second tubular attachment are rigid.

4. The filling device according to claim 1, wherein each of the first tubular attachment and the second tubular attachment is attached to the container at about its inner end, wherein each of the first tubular attachment and the second tubular attachment is attached to the container near the bottom of the container, and wherein each of the first tubular attachment and the second tubular attachment at least in part projects outward from the exterior of the container.

5. The filling device according to claim 1, wherein each of the first tubular attachment and the second tubular attachment is of one-piece construction with the container.

6. The filling device according to claim 1, wherein each of the first tubular attachment and the second tubular attachment has an exterior surface, and wherein the exterior surface of each of the first tubular attachment and the second tubular attachment is provided with one or more barbs, ridges, or ribs configured to provide for secure and sealing engagement with an end of a hose.

7. The filling device according to claim 1, wherein each of the first tubular attachment and the second tubular attachment has an exterior surface and a length, and wherein the exterior surface of each of the first tubular attachment and the second tubular attachment is provided with a plurality of barbs, ridges, or ribs distributed along the length of a corresponding one of the first tubular attachment and the second tubular attachment, and the plurality of barbs, ridges, or ribs being configured to provide for secure and sealing engagement of the corresponding one of the first tubular attachment and the second tubular attachment with an end of a hose.

8. The filling device according to claim 1, wherein each of the plurality of barbs, ridges, or ribs is annular.

9. The filling device according to claim 1, wherein the surrounding wall is annular in cross section and the container is cylindrical.

10. The filling device according to claim 1, wherein each of the first tubular attachment and the second tubular attachment is annular in cross section.

11. The filling device according to claim 1, wherein the screw thread of the threaded portion of the container is of a standard type that is configured to be capable of threaded engagement with a screw thread of a filtered water outlet of at least one preexisting, currently commercially available water filtration system, or a screw thread of a water outlet of a preexisting, currently commercially available water bottle or other water supply container, to provide for secure, water-tight fluid communication and engagement between the interior of the container and the filtered water outlet of the water filtration system or the water outlet of the water bottle or the water supply container.

12. The filling device according to claim 1, wherein the screw thread of the threaded portion of the container is of a standard type that is configured to be capable of threaded engagement with a screw thread of a filtered water outlet of a plurality of preexisting, currently commercially available water filtration systems to provide for secure, water-tight fluid communication and engagement between the interior of the container and the filtered water outlet of each of the plurality of water filtration systems.

13. The filling device according to claim 1, wherein the bottom of the container is closed off by a circular bottom plate, the bottom plate having an interior surface and an exterior surface, the interior surface of the bottom plate providing a bottom surface of the interior of the container, wherein the inner end opening of the first tubular attachment is located at or near the bottom surface of the interior of the container, and wherein the inner end opening of the second tubular attachment is located at or near the bottom surface of the interior of the container on an opposite side of the surrounding wall of the container relative to the inner end opening of the first tubular attachment.

14. The filling device according to claim 1, wherein the first tubular attachment and the second tubular attachment are attached to the container at or near the bottom of the container, wherein the first tubular attachment and the second tubular attachment extend outward from the exterior of the container in opposite directions that are transverse to the longitudinal axis of the container.

15. The filling device according to claim 1, wherein the open top of the container has a rim, wherein the threaded portion of the container comprises a female thread provided on the interior surface of the surrounding wall, wherein a portion of the surrounding wall located between the threaded portion of the container and the bottom of the container is of increased wall thickness to form an abutment on the interior of the container to act as a stop for the filtered water outlet of the water filtration system or the water outlet of the water bottle or the water supply container to abut against when the filtered water outlet of the water filtration system or the water outlet of the water bottle or the water supply container is fully tightened into the threaded portion of the container in cases where the filtered water outlet of the water filtration system or the water outlet of the water bottle or the water supply container lacks a properly located flange or other abutting surface capable of abutting the rim of the open top of the container to stop the filtered water outlet of the water filtration system or the water outlet of the water bottle or the water supply container from excessive ingress into the container.

16. The filling device according to claim 1, wherein the interior of the container has a bottom surface that has a perimeter that has an entire extent, wherein the portion of the surrounding wall that is of the increased wall thickness extends from the abutment to the bottom of the container over the entire extent of the perimeter of the bottom surface of the container such that the abutment is in the form of an annular step in the interior of the container.

17. The filling device according to claim 11, wherein the surrounding wall has an outer perimeter, wherein the exterior of the container adjacent or near the open top of the container is provided with a surface structure that affords a better grip to a user to help the user to resist or apply torque to achieve threaded engagement between the container and other objects, wherein the surface structure is selected from the group consisting of:
a) longitudinal ribs evenly distributed about the outer perimeter of the surrounding wall,
b) longitudinal ridges evenly distributed about the outer perimeter of the surrounding wall,
c) longitudinal grooves or troughs evenly distributed about the outer perimeter of the surrounding wall,
d) longitudinal serrations evenly distributed about the outer perimeter of the surrounding wall,
e) a pattern of stippling distributed about the outer perimeter of the surrounding wall,
f) knurling distributed over the outer perimeter of the surrounding wall,
g) a pattern of projections distributed over the outer perimeter of the surrounding wall, and
h) an array of teeth distributed over the outer perimeter of the surrounding wall.

18. The filling device according to claim 17, further comprising a closure for the open top of the container for securely closing off the open top of the container when the filling device is not being used to add fluid to the hydration bladder.

19. The filling device according to claim 18, wherein the closure comprises:
a cap plate having a circumference, an outer diameter, a top surface, a bottom surface, and a circumferential surface extending between the top surface of the cap plate and the bottom surface of the cap plate and along the circumference of the cap plate; and
a threaded plug having a screw thread configured for mating engagement with the threaded portion of the container, the threaded plug extending out from the bottom surface of the cap plate, the threaded plug having an outer diameter, wherein the outer diameter of the threaded plug is smaller than the outer diameter of the cap plate.

20. The filling device according to claim 19, wherein a decorative design in the form of a relief is incorporated into the cap plate on the top and circumferential surfaces of the cap plate, wherein a portion of the relief protrudes outward beyond the circumference of the cap plate to provide a better purchase to a user for applying torque to the closure for unscrewing or tightening the closure on the open top of the container.

21. A hydration device comprising the filling device according to claim 18, wherein the hydration device further comprises:
a hydration bladder configured for storing a quantity of water and providing water on demand to a user, the hydration bladder having a dispensing outlet configured for attachment of a hose;
a first hose section having a first end portion and a second end portion, the first end portion of the first hose section being connected to the dispensing outlet of the hydration bladder and the second end portion of the first hose section being connected to the first tubular attachment of the filling device, the first hose section providing for fluid travel between the hydration bladder and the filling device;
a mouthpiece; and
a second hose section having a first end portion and a second end portion, the first end portion of the second hose section being connected to the second tubular attachment of the filling device and the second end portion of the second hose section being connected to the mouthpiece, the second hose section providing for fluid travel between the filling device and the mouthpiece,
wherein the mouthpiece is configured to allow the user to obtain water from the hydration bladder and into their mouth by creating suction in their mouth while having at least a portion of the mouthpiece inserted in their mouth, wherein the open top of the filling device is configured for attachment of an outlet of a water filtration system or an outlet of a water supply container for adding water to the hydration bladder, and wherein the outlet of the water filtration system or the outlet of the water supply container can be attached to the open top of the container of the filling device for fluid communication between the interior of the container of the filling device and the outlet of the water filtration system or the outlet of the water supply container when the closure is removed from the container of the filling device.
